(19) United States
(12) Patent Application Publication
(10) Pub. No.: US 2015/0042486 A1
(43) Pub. Date: Feb. 12, 2015

(54) COMMUNICATION IN A SUBSEA WELL CONTROL SYSTEM

(71) Applicant: Vetco Gray Controls Limited, Bristol (GB)

(72) Inventors: Silviu Puchianu, Bristol (GB); Graham Morley, Bristol (GB); Andrew Packham, Bristol (GB); Hilton Smart, Bristol (GB); Julian Davis, Bristol (GB)

(73) Assignee: Vetco Gray Controls Limited, Bristol (GB)

(21) Appl. No.: 14/374,565

(22) PCT Filed: Jan. 22, 2013
(86) PCT No.: PCT/EP2013/051160

§ 371 Date: Jul. 25, 2014

(30) Foreign Application Priority Data
Jan. 26, 2012 (EP) 12152683.4

(51) Int. Cl. H04B 13/02; H01B 7/14

(52) U.S. Cl. CPC H04B 13/02; H01B 7/14
USPC 340/850

(57) ABSTRACT

A communication arrangement for a subsea well control system, comprising an umbilical between a topside location and a subsea location, an electrical conductor in said umbilical, and a data transmission system configured to transmit and receive data between said locations via said conductor, wherein a return path for said data comprises the sea.

### BACKGROUND OF THE INVENTION

Embodiments of the present invention relate to communication in a subsea well control system, such as a control system for a subsea well hydrocarbon extraction facility.

In a communications and power system (CAPS) based subsea control well system (such as a subsea control system for a subsea well hydrocarbon extraction facility), the cost of the copper conductors, within an umbilical between a surface control platform and the subsea well complex, used for data communications becomes significant due to the long offsets.

### SUMMARY OF THE INVENTION

According to an embodiment of the present invention, there is provided a communication arrangement for a subsea well control system, comprising an umbilical between a topside location and a subsea location, an electrical conductor in the umbilical and means for transmitting and receiving data between the locations via the conductor, wherein a return path for the data comprises the sea. Typically, the means for transmitting and receiving data comprises: first data supply means, at the topside location; second data supply means, at the subsea location; first data receiving means, at the topside location, for receiving data from the second data supply means via the umbilical; and second data receiving means, at the subsea location, for receiving data from the first data supply means via the umbilical.

Such an arrangement could comprise first switching means, at the topside location, and second switching means, at the subsea location, the arrangement being such that, when the first data supply means transmits data to the second data receiving means, the second switching means connects the conductor to the sea and, when the second data supply means transmits data to the first data receiving means, the first switching means connects the conductor to the sea.

In this case, in one embodiment: the first data supply means comprises a first direct current source and means for alternately switching the first switching means between a position in which it connects the first source to the conductor and a position in which it connects the conductor to the sea, in dependence on the data to be transmitted to the second receiving means; and the second data supply means comprises a second direct current source and means for alternately switching the second switching means between a position in which it connects the second source to the conductor and a position in which it connects the conductor to the sea, in dependence on the data to be transmitted to the first receiving means.

In another embodiment, the first data supply means comprises a first data source and the second data supply means comprises a second data source, the arrangement being such that the first switching means connects the first source to the conductor for transmitting data to the second receiving means and the second switching means connects the second source to the conductor for transmitting data to the first receiving means. Each of the first and second sources could comprise a source of digital data or a source of modulated analogue data.

According to another embodiment of the present invention, there is provided a method of communication in a subsea well control system which comprises an umbilical between a topside location and a subsea location and an electrical conductor in the umbilical, the method comprising using means for transmitting and receiving data to transmit between the locations via the conductor and using the sea as a return path for the data.

### BRIEF DESCRIPTION OF THE DRAWINGS

FIGS. 1 and 2 illustrate a first embodiment of the invention in two conditions;

FIGS. 3 and 4 illustrate a second embodiment of the invention in two conditions; and

FIGS. 5 and 6 illustrate a third embodiment of the invention in two conditions.

### DETAILED DESCRIPTION OF THE INVENTION

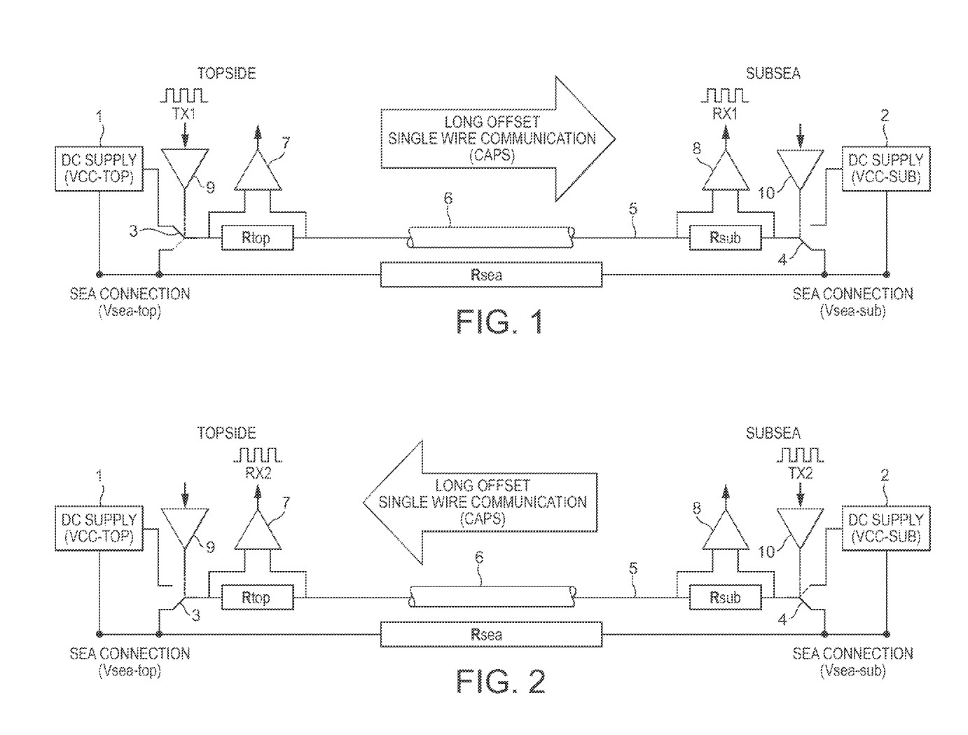

Referring first to FIGS. 1 and 2, in a well control system (such as a control system for a subsea well hydrocarbon extraction facility), reference numeral 1 designates a direct current (DC) supply at a topside location for supplying a voltage VCC-TOP and reference numeral 2 designates a DC supply at a subsea location for supplying a voltage VCC-SUB. Reference numeral 3 designates a switch at the topside location and reference numeral 4 designates a switch at the subsea location. There is a long offset between supplies 1 and 2, there being between them an electrical conductor 5 in the form of a single wire in an umbilical 6 for transmitting communications between from the topside to subsea and vice-versa, the conductor 5 not carrying power.

Rtop designates a resistor at the topside location in series with conductor 5, across which resistor is an amplifier 7 for topside reception of data from the subsea location and Rsub designates a resistor at the subsea location in series with conductor 5 across which resistor there is an amplifier 8 for reception of data from the topside location. At the topside location, for transmitting data to the subsea location, a digital signal TX1 can cause switch 3 to operate via an amplifier 9 alternately to connect and disconnect in a predetermined manner the voltage from supply 1 to conductor 5, in which condition switch 4 connects conductor 5 to the sea at a sea connection (see FIG. 1). At the subsea location, for transmitting data to the topside location, a digital signal TX2 can cause switch 4 to operate via an amplifier 10 to alternately connect and disconnect in a predetermined manner the voltage from supply 2 to conductor 5, in which condition switch 3 is connected to the sea at a sea connection (see FIG. 2). At the topside location, the sea connection is at a potential of Vsea-top and at the subsea end the sea connection is at a potential of Vsea-sub.

In FIG. 1, communication of data is from the topside location to the subsea location in dependence on the operation of switch 3 and in FIG. 2, communication of data is from the subsea location to the topside location in dependence on the operation of switch 4, in each case the communication return path is via the sea, the resistance of the sea water being Rsea.

When transmitting data from the topside location to the subsea location (FIG. 1), the received signal being RX1, VCC-TOP must be large enough to compensate for the voltage drop along the conductor 5 of the umbilical 6 (Vumbilical-drop).

For example: VCC−TOP=Vumbilical-drop+V digital-offset, where:

Vdigital-offset=Min [Abs(Vsea-top−Vsea-sub)+Vdigital],

where Vdigital is recommended to be at least 24 volts.

Thus, the subsea transmitted signal is as follows:
Logic 1: voltage drop across resistor Rsub when switch 3 is connected to supply 1 (approx Vdigital)
Logic 0: voltage drop across resistor Rsub when switch 3 is connected to the sea (approx 0 volts)

When transmitting data from the subsea location to the topside location (FIG. 2), the received signal being RX2, similar conditions as per the above supply to VCC-SUB.

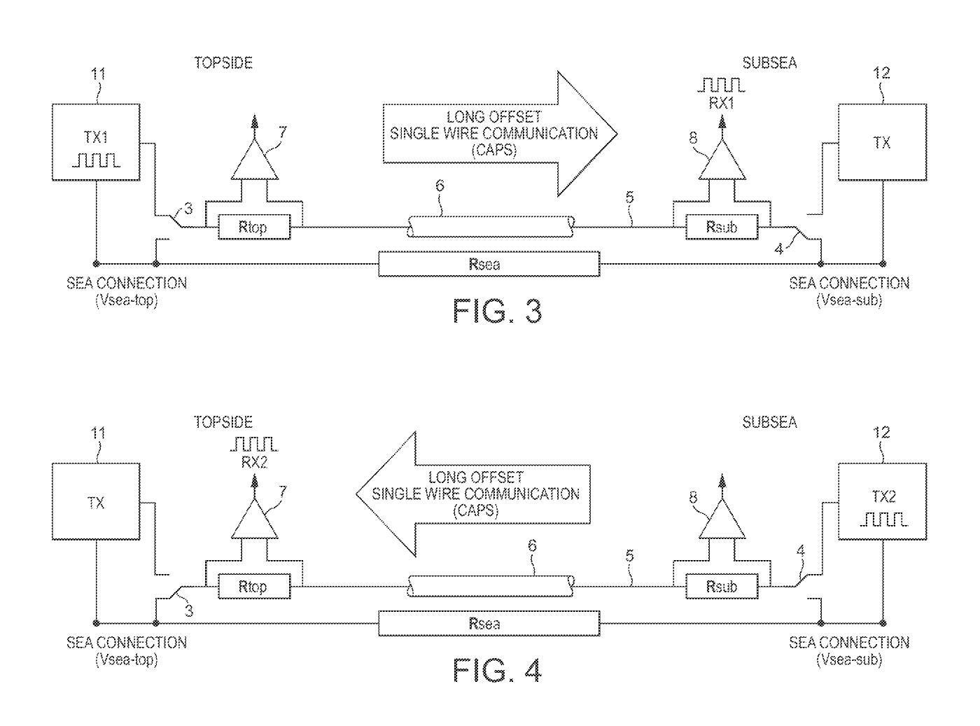

Referring to FIGS. 3 and 4, in which items which correspond with those in FIGS. 1 and 2 have the same reference numerals as in FIGS. 1 and 2, reference numerals 11 and 12 designate digital data supplies at the topside and subsea locations respectively. For transmitting data from the topside location to the subsea location, switch 3 is connected to supply 1 and switch 4 is connected to the sea (FIG. 3); and for transmitting data from the subsea location to the topside location, switch 4 is connected to supply 2 and switch 3 is connected to the sea (FIG. 4).

As with FIGS. 1 and 2, the communication of data from the topside location to the subsea location and vice-versa is via conductor 5 with the return path via the sea. The DC level of the digital signals supplied by supplies 11 and 12 should meet the conditions set out above with reference to FIGS. 1 and 2 for VCC-TOP and VCC-SUB.

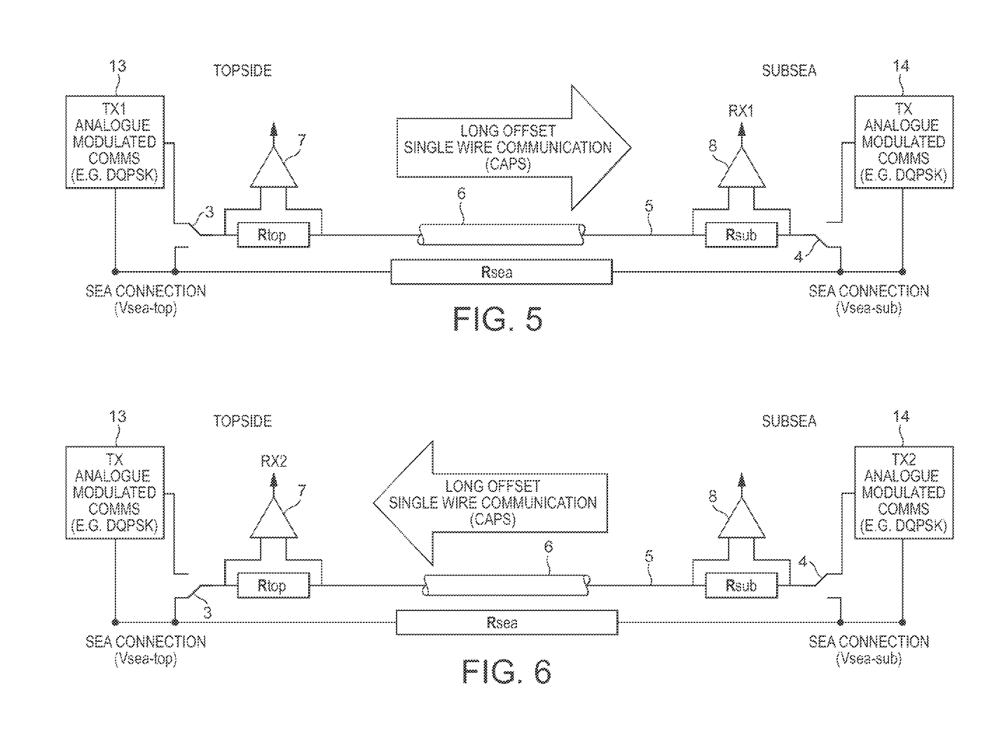

FIGS. 5 and 6 illustrate an alternative to the embodiment of FIGS. 3 and 4 in which supplies 11 and 12 are replaced by analogue modulated communication supplies 13 and 14 at the topside and subsea locations respectively, for example supplying analogue signals digitally encoded, such as by differential quadrature phase shift keying (DQSPK).

Embodiments of the present invention substantially reduce the umbilical costs by the reduction of conductors.

The written description uses examples to disclosure the invention, including the best mode, and also to enable any person skilled in the art to practice the invention, including making and using any devices or systems and performing any incorporated processes. The patentable scope of the invention is defined by the claims, and may include other examples that occur to those skilled in the art. These other examples are intended to be within the scope of the claims if they have structural elements that do not differ from the literal language of the claims, or if they include equivalent structural elements with insubstantial differences from the literal languages of the claims.

What is claimed is:

1. A communication arrangement for a subsea well control system, the communication arrangement comprising:
an umbilical between a topside location and a subsea location in a sea;
an electrical conductor in the umbilical; and
a data transmission system configured to transmit and receive data between the topside location and the subsea location via the electrical conductor,
wherein a return path for the data comprises the sea.

2. The communication arrangement according to claim 1, wherein the data transmission system comprises:
a first data supplier at the topside location;
a second data supplier at the subsea location;
a first data receiver at the topside location, the first data receiver configured to receive data from the second data supplier via the umbilical; and
a second data receiver at the subsea location, the second data receiver configured to receive data from the first data supplier via the umbilical.

3. The communication arrangement according to claim 1, further comprising:
a first switch at the topside location; and
a second switch at the subsea location,
wherein the first data supplier transmits data to the second data receiver, the second switch connects the conductor to the sea, and, when the second data supplier transmits data to the first data receiver, the first switch connects the conductor to the sea.

4. The communication arrangement according claim 2, wherein:
the first data supplier comprises a first direct current source and a first controller to alternately switch the first switch between a position in which the first switch connects the first direct current source to the conductor, and a position in which the first switch connects the conductor to the sea, in dependence on the data to be transmitted to the second receiver; and
the second data supplier comprises a second direct current source and a second controller configured to alternately switch the second switch between a position in which the second switch connects the second source to the conductor, and a position in which the second switch connects the conductor to the sea, in dependence on the data to be transmitted to the first receiver.

5. The communication arrangement according to claim 2, wherein the first data supplier comprises a first data source and the second data supplier comprises a second data source, wherein the first switch connects the first source to the electrical conductor for transmitting data to the second receiver, and the second switch connects the second source to the electrical conductor for transmitting data to the first receiver.

6. The communication arrangement according to claim 1, wherein each of the first source and the second source comprises a source of digital data.

7. The communication arrangement according to claim 1, wherein each of the first source and the second source comprises a source of modulated analogue data.

8. A method of communication in a subsea well control system including an umbilical between a topside location and a subsea location in a sea and an electrical conductor in the umbilical, the method comprising:
transmitting and receiving data between the topside location and the subsea location via the electrical conductor by a data transmission system; and
using the sea as a return path for the data.

9. The method according to claim 8, wherein the data transmission system comprises:
a first data supplier at the topside location;
a second data supplier at the subsea location;
a first data receiver at the topside location, the first data receiver configure to receive data from the second data supplier via the umbilical; and
a second data receiver at the subsea location, the second data receiver configure to receive data from the first data supplier via the umbilical.

10. The method according to claim 8, wherein the subsea well control system further comprises
a first switch at the topside location; and
a second switch at the subsea location,
wherein, when the first data supplier transmits data to the second data receiver, the second switch connects the electrical conductor to the sea, and, when the second data supplier transmits data to the first data receiver, the first switch connects the conductor to the sea.

11. The method according to claim 8, wherein the first data supplier comprises a first direct current source, and the second data supplier comprises a second direct current source, the method further comprising,
alternately switching the first switch between a position in which the first switch connects the first source to the electrical conductor, and a position in which the first switch connects the electrical conductor to the sea, in dependence on the data to be transmitted to the second receiver; and
alternately switching the second switch between a position in which the second switch connects the second source to the electrical conductor and a position in which the second switch connects the electrical conductor to the sea, in dependence on the data to be transmitted to the first receiver.

12. The method according to claim 8, wherein the first data supplier comprises a first data source and the second supplier comprises a second data source, the method further comprising:
connecting, by the first switch, the first data source to the electrical conductor for transmitting data to the second receiver; and
connecting, by the second switch, the second data source to the electrical conductor for transmitting data to the first receiver.

13. The method according to claim 8, wherein each of the first source and the second source comprises a source of digital data.

14. The method according to claim 8, wherein each of the first source and the second source comprises a source of modulated analogue data.
